(19) United States
(12) Patent Application Publication
(10) Pub. No.: US 2009/0115210 A1
(43) Pub. Date: May 7, 2009

(54) CARRIER DEVICE

(76) Inventor: Richard WILLIAMS, Madison Township, PA (US)

Correspondence Address: ZALE Patent Law, 121 Old Orchard Road, Clarks Summit, PA, 18503-2053, US

(21) Appl. No.: 12/260,371

(22) Filed: Oct. 29, 2008

Related U.S. Application Data
(60) Provisional application No. 61/001,717, filed on Nov. 2, 2007.

(51) Int. Cl. B65G 7/12

(52) U.S. Cl. 294/17

(57) ABSTRACT

The block carrier device [1000] for holding and carrying a block [3] includes a slider assembly [1200] slideably attached to a main body [1110] and a handle assembly [1500] pivotally attached to the main body [1110]. The slider assembly [1200] includes a slide [1250] which slides to and attaches at one of a plurality of adjustment points [1111]. This allows the carrier device [1000] to carry various block sizes. The slider assembly [1200] includes horizontal cross bars [1230] extending from the slide [1250]. At least two cross bar fingers [1270] extend downwardly. Handle assembly [1500] includes a handle finger [1530] which is a curved extension of the handle [1510]. As handle [1510] is lifted it pivots handle finger [1530] to compress block [3] between the cross bar fingers [1270] and the handle finger [1530] allowing block [3] to be held and carried. The carrier device [1000] is adaptable to carry odd sized or damaged blocks securely.

### CROSS REFERENCE TO RELATED APPLICATIONS

This application is a Continuation-In-Part of U.S. Provisional Patent Application Ser. No. 61/001,717 “Block Carrier Device” filed Nov. 2, 2007 by the same inventor as the present application, Richard Williams. The present application claims priority from this application and incorporates all material as if it were set forth in its entirety herein.

### FEDERAL SPONSORED RESEARCH

Not Applicable

### SEQUENCE LISTING OR PROGRAM

Not Applicable

### BACKGROUND OF THE INVENTION

1. Field of the Invention

The present invention relates to a device for holding and carrying objects and more specifically for a device for holding and carrying weathered and standard retaining wall block and other concrete masonry block and brick of various shapes and sizes.

2. Discussion of Related Art

Construction using blocks is a large business. Power equipment is available for moving and positioning large amounts of objects. However, it is sometimes necessary to move and place individual objects, such as blocks. The use of power equipment is not feasible for such uses.

In the past there have been devices for lifting, holding and positioning individual blocks. Some of these employed flat sides which did not work well with worn or irregular blocks.

Some employed four points of attachment to grab and hold blocks. Again, if they were irregular or missing a piece, these could not be easily lifted by these devices.

Also, due to irregularities, the four points may not make equal contact or exert equal pressure on the block surface. In this case, the block may pivot or slip resulting in improper positioning.

Currently, there is a need for a device which holds both regular and irregular objects securely and allows a user to accurately position the block.

### SUMMARY OF THE INVENTION

One embodiment of the present invention is a carrier device [1000] for carrying an object [3] comprising:
a) a handle assembly [1500] being substantially horizontal, the handle assembly [1500] having:
   i. a handle [1510], and
   ii. a handle finger [1530] extending downwardly alongside a front side of the object [3],
b) a main body [1110] having a front side and a rear side, the rear side having at least one cross bar finger [1270] extending downwardly alongside a rear side of said object [3],
c) a pivot assembly [1700] for pivotally attaching the handle assembly [1500] to the main body [1110] at a pivot [1710] such that when the handle [1510] is lifted vertically, it causes the handle finger [1530] to press the object [3] against the cross bar finger [1270] holding said object [3].

The invention may also be embodied as a carrier device [1000] for holding and carrying various sized objects [3] comprising:
a) a main body [1110] extending generally horizontally;
b) a slider assembly [1200] having a slide [1250] slideably attached to the main body [1110] having at least one cross bar [1230] attached to the slide [1250] and extending horizontally at least partially across main body [1110] and at least one cross bar finger [1270] attached to the cross bar [1230] extending downwardly;
c) a handle assembly [1500] having a handle [1510] for carrying the carrier device [1000], and a handle finger [1530] angled with respect to the handle for making contact with said object [3];
d) a pivot assembly [1700] for attaching the handle assembly [1500] to the main body [1110] allowing the handle finger [1530] of the handle assembly [1500] to pivot when the handle [1510] is lifted to compress said object [3] between the handle finger [1530] and the at least one cross bar finger [1270] holding and carrying object [3].

### OBJECTS OF THE INVENTION

It is an object of the present invention to provide a block carrier device which securely holds both regular and irregular blocks with three points of contact.

It is another object of the present invention to provide a block carrier device which allows accurate positioning of a block.

It is another object of the present invention to provide a block carrier device which is easy to use.

It is another object of the present invention to provide a block carrier device which is inexpensive to manufacture.

It is another object of the present invention to provide a block carrier device which has fewer parts than prior art devices.

### BRIEF DESCRIPTION OF THE DRAWINGS

The advantages of the instant disclosure will become more apparent when read with the specification and the drawings, wherein:

FIG. 1 is a perspective view of one embodiment of the carrier device 1000 according to the present invention.

FIG. 2 is side elevational view of the carrier device 1000 carrying a cinder block from two outside surfaces.

FIG. 3 is plan view of the carrier device 1000 shown in FIG. 2 carrying a cinder block from two outside surfaces.

FIG. 4 is an elevational view from the front of the carrier device 1000 shown in FIGS. 2, 3 according to the present invention carrying a cinder block.

FIG. 5 is plan view of the carrier device 1000 carrying a cinder block from one of the block's inside surfaces and one of its outside surfaces.

FIG. 6 is plan view of the carrier device 1000 carrying a broken cinder block from one of the block's inside surfaces and one of its outside surfaces.

FIG. 7 is a perspective view of another embodiment of the present invention.

FIG. 8 is a top view of the embodiment of FIG. 7.

FIG. 9 is a side elevational view of the embodiment shown in FIGS. 7 and 8.

### DETAILED DESCRIPTION OF THE INVENTION

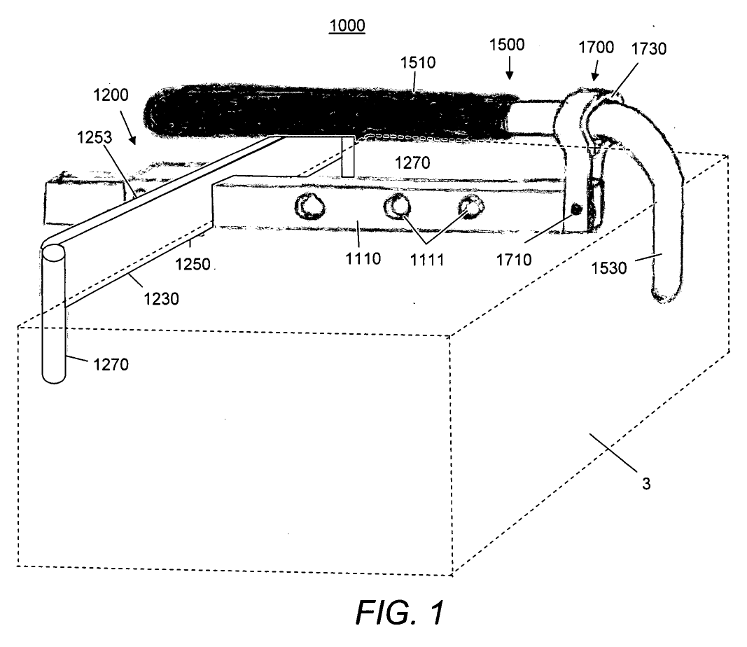

FIG. 1 is a perspective view of one embodiment of the block carrier device 1000 according to the present invention.

Carrier device 1000 is shown attached to a block 3, which may be a cinder block, a concrete block or retaining wall block. However, it is to be understood that the present carrier device 1000 may lift and carry any number of objects including logs, lumber, machinery, boxes, crates, etc.

Carrier device 1000 is comprised of a main body 1110 having a plurality of adjustment points 1111. These are shown in this embodiment as adjustment holes.

A slider assembly 1200 includes a slide 1250 slideably attached to main body 1110. It may be moved to an adjustment point 1111 and secured at this point with a securing means 1253 such as slide pin. This allows the carrier device 1000 to be adjusted to carry different sized blocks.

Slider assembly 1200 also includes at least one cross bar 1230. The cross bar has at least one cross bar finger 1270 extending from it. Cross bar fingers 1270 are designed to press against and hold one side of block 3.

A pivot assembly 1700 is connected to the other end of main body 1110. It includes a pivot 1710 attached to and pivoting on main body 1110. Pivot 1710 attaches to a handle attachment 1730. Handle attachment 1730 attaches to a handle assembly 1500.

Handle assembly 1500 is constructed of a handle 1510 used to lift the carrier device 1000 and block 3. Handle assembly 1500 also includes a handle finger 1530 which is shaped to make contact with the other side of block 3. As one lifts on handle 1510, it pivots to force handle finger 1530 against the side of block 3. Block 3 is held between cross bar fingers 1270 and handle finger 1530. As one lifts handle 1510, the force placed on block 3 is based upon its weight. Heavier blocks produce more force. Heavier blocks also require more force on the fingers to resist slipping.

In order to distribute the force, the fingers may have differing shapes such as being flattened where they make contact with block 3.

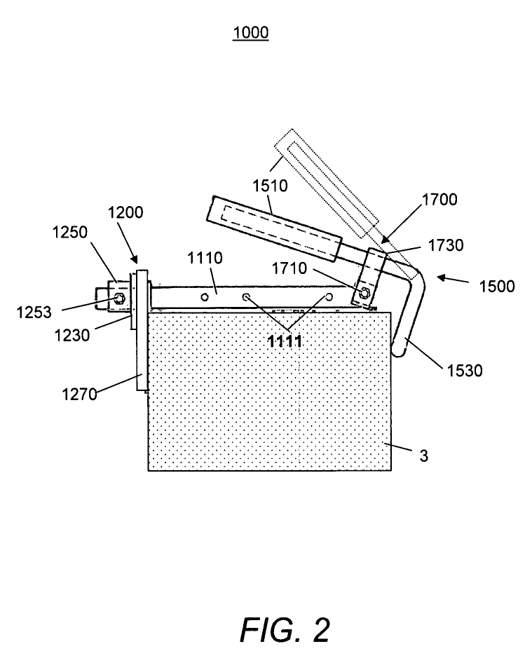

FIG. 2 is side elevational view of the block carrier device 1000 carrying a cinder block from two outside surfaces.

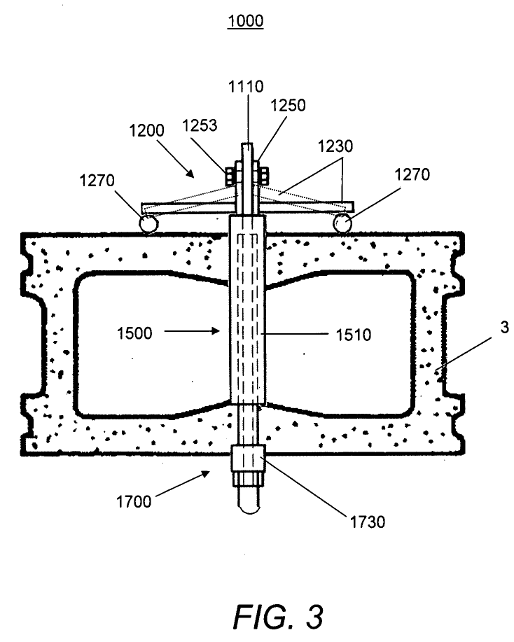

FIG. 3 is plan view of the block carrier device 1000 shown in FIG. 2 carrying a cinder block from two outside surfaces.

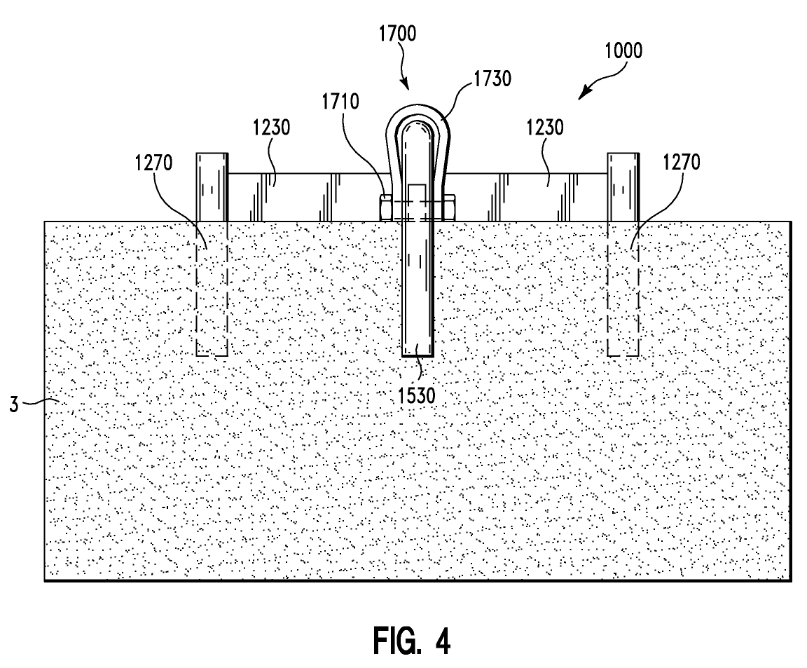

FIG. 4 is an elevational view from the front of the block carrier device 1000 according to the present invention carrying a cinder block.

As shown from various views of FIGS. 2, 3 and 4, it can be seen in this embodiment that the slide 1250 of slider assembly 1200 is attached to main body 1110 at an adjustment point 1111 by a securing means 1253.

Handle assembly 1500 is also attached to the main body 1110 through pivot assembly 1700. Therefore, handle finger 1530 is allowed to pivot a few inches based upon the position of handle 1510.

This allows the carrier device to adjust a few inches larger or smaller at any adjustment point. Therefore, if the adjustment points are spaced less than a few inches apart, the carrier device 1000 can adjust to any size block between a minimum size and a maximum size depending upon the size of the carrier device 1000.

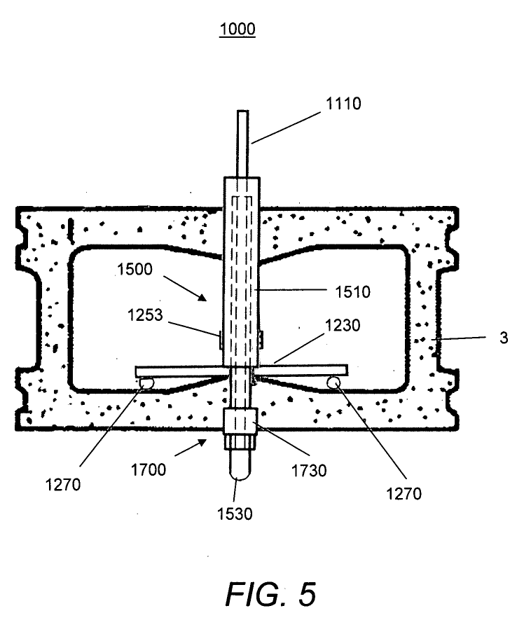

FIG. 5 is plan view of the block carrier device 1000 shown in FIGS. 2, 3 carrying a cinder block from one of the block's inside surfaces and one of its outside surfaces. This shows the versatility of the present invention. It may attach to a variety of surfaces allowing blocks and other objects to be carried easily.

In an alternative embodiment, spades may be attached to each of the cross bar fingers 1270 and handle finger 1530. Therefore, these narrow spades may fit in cracks between paver blocks, and grab the outer sides of the paver blocks allowing them to be lifted out of a tight formation with less effort.

This is an advantage above prior art designs which are set to carry standard sized blocks. Non-standard sized blocks cannot be carried.

Also, if the blocks are weathered, damaged or are not of a regular rectangular shape, they cannot be carried by prior art devices.

Since the device may be constructed with three points of contact, it may carry a variety of shapes. Just as a table having four legs may wobble, a table with three points of contact makes a solid base.

Similarly, three points of contact create a solid grip which two flat plates or four rectangular points of contact may not achieve.

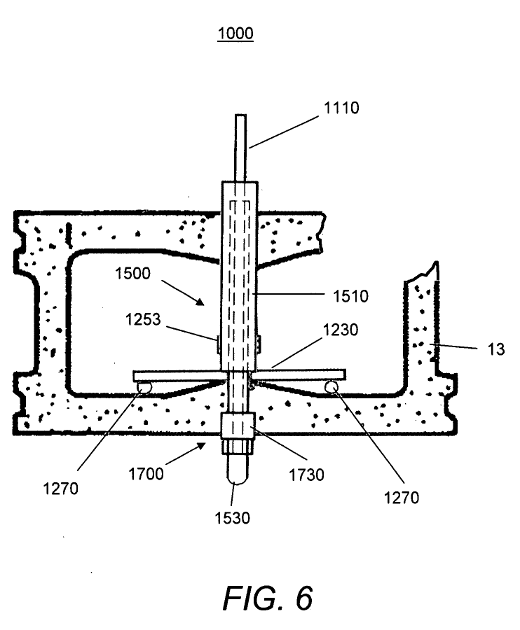

FIG. 6 is plan view of the block carrier device 1000 carrying a broken cinder block from one of the block's inside surfaces and one of its outside surfaces.

It can be seen here that a broken block 13, missing the upper right corner, can be easily carried with the block carrier 1000. This would not be possible with a prior art four-prong carrier. A four-prong device would need a point of contact where the corner of block 13 is missing.

The carrier device according to the present invention is made in a very simple, but effective manner. It can be disassembled and stored in a small space. It is not heavy and does not significantly add to the weight that a user lifts as they repeatedly carry and stack blocks during construction or other purposes. It is designed to replace the need for multiple lifters for the various types of products.

It is designed to be very sturdy with little flexing. This is important, since it will be used for positioning the blocks. Less flex means less readjustments and faster construction. This leads to less labor and increased savings.

Since carrier device 1000 is designed as a simple and small device, it also easily aids in the accurate positioning of blocks. Since it may be used with one hand, it will aid in the stacking and positioning of blocks for construction and other purposes.

In an alternative embodiment of the present invention as shown in phantom in FIG. 2, the bend angle between handle 1510 and handle finger 1530 may be adjusted to cause handle to become angled upward when handle finger 1530 comes in contact with block 3. Also, a handle having two grips, such as a “T” handle, may be employed.

In another alternative embodiment as show in phantom in FIG. 3, cross bars 1230 may angle toward block 3 to further ensure that cross bar fingers 1270 make contact with block 3 without cross bar 1230 making contact with block 3.

In another alternative embodiment, all fingers may be made to have soft non-scratching frictional material where they make contact with block 3. These may have a flexible rubber or polymer coating.

This would be useful in picking up and carrying blocks which are prone to scratching. This may be, for example, matt face, splitface, glazed, glass or ceramic blocks etc.

In another alternative embodiment, the cross bar fingers 1270 of FIGS. 1-6 may be adjustable such that they may be moved closer to each other, or offset. This allows the fingers to be placed at locations which could grip the object being picked up.

Cross bar fingers 1270 and handle finger 1530 may be made to be angularly adjusted in such a way that they may be fixed at that angle. This would allow the carrier device 1000 to more effectively pick up and carry irregularly shaped objects which standard carriers can not.

The present invention therefore is a significant advancement over the prior art.

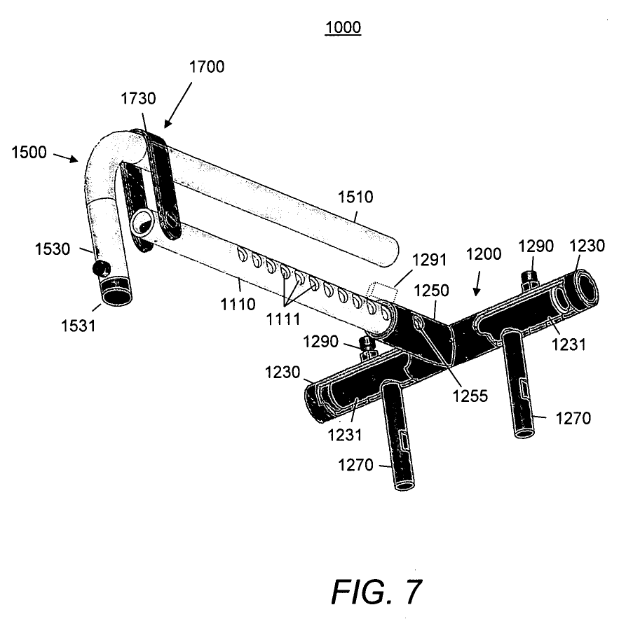

FIG. 7 is a perspective view of another embodiment of the present invention.

In this embodiment, the main body 1110 has a tubular shape. It includes holes 1111 as adjustment points. Slide 1250 is allowed to slide over main body 1110 to the proper point in which a hole 1255 of slide 1250 lines up with a hole of the adjustment point 1111. A bolt or other securing means is placed through hole 1255 of slide 1250 and main body 1110 holding them in their relative positions. This allows for easy adjustment of the device for carrying different sized blocks.

In this embodiment, cross bar 1230 is shown in partial cut away view showing internal cross bar sliders 1231. These cross bar sliders 1231 are each attached to a cross bar finger 1270. Therefore, by sliding each cross bar slider 1231, one may adjust the location of each cross bar finger 1270 independently. This allows for carrying irregular shaped objects or broken blocks.

Each cross bar slider 1231 is secured by a cross bar securing device 1290. Cross bar securing device 1290 may be any known device for holding cross bar slider 1231 in place, such as a screw in a threaded hole which presses on cross bar slider 1231 when screwed in.

The handle assembly 1500 is similar to the previous embodiment having a handle finger 1530 and handle 1510. Handle finger 1530 may include a removable point 1531. The removable point 1531 may be a flat blade, a ribbed finger, a shape resembling a tooth or other to get between blocks such as paving stones and pull them up. This is also true of cross bar fingers 1270.

Since they are replaceable, once they are broken, bent or dull, they may be replaced.

If an item being picked up is easily damaged, the handle finger 1530 and the cross bar fingers 1270 may be covered with rubber boots or a sheath to prevent damage.

Handle assembly 1500 is held to the main body 1110 at a pivot 1710 of a pivot assembly 1700.

In an alternative embodiment, a stop 1291 may be employed to stop handle 1510 from contacting the main body 1110.

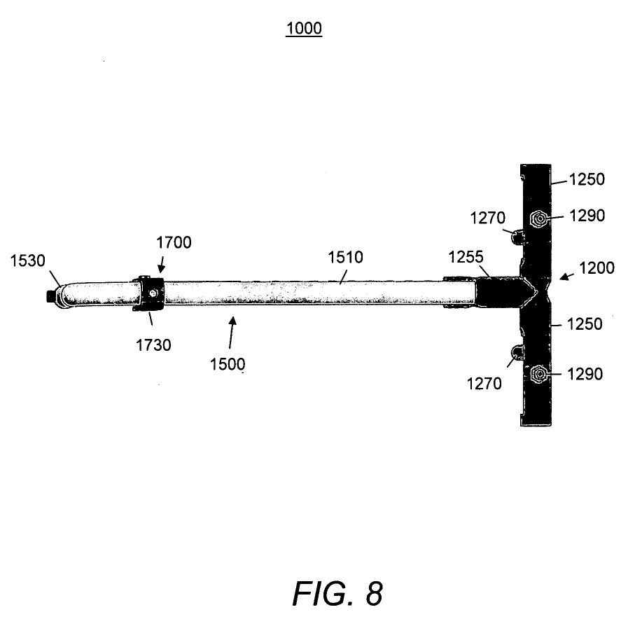

FIG. 8 is a top view of the embodiment of carrier 1000 shown in FIG. 7.

Here handle assembly 1500 with handle 1510 extending horizontally, are visible. The pivot assembly 1700 attached handle assembly 1500 to slider assembly 1200. Only slide 1250 with cross bar securing devices 1290 and cross bar fingers 1270 of the slider assembly are visible.

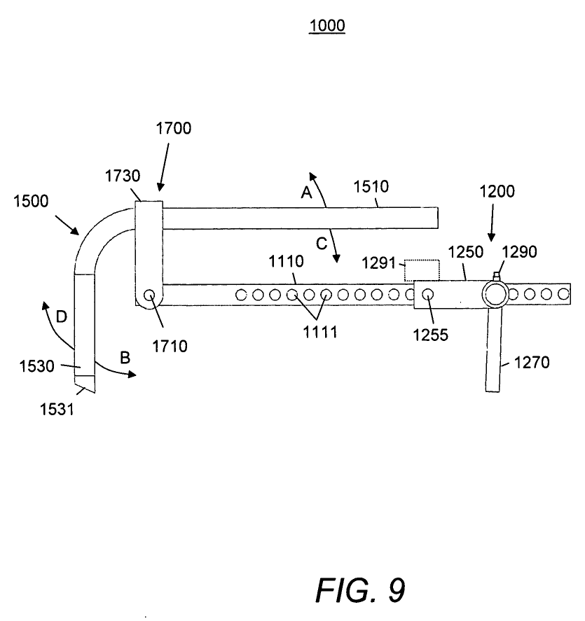

FIG. 9 is a side elevational view of embodiment of the carrier 1000 shown in FIGS. 7 and 8. The main body 1110 has a tubular shape. It includes holes 1111 as adjustment points. Other types of attachments may also be used here.

Slider assembly 1200 is allowed to slide over main body 1110 to the proper point to adjust the device 1000 to carry a specific object.

Each cross bar slider 1231 is secured by a cross bar securing device 1290. Cross bar securing device 1290 is used to secure cross bar fingers 1270 in place.

As handle assembly 1500 is lifted in the direction marked by arrow “A”, handle finger 1530 rotates about pivot 1710 in the direction marked by arrow “B”. This causes handle finger 1530 to press against an object being carried between handle finger 1530 and cross bar fingers 1270. The pressure causes friction allowing the device 1000 to pick up the object.

As one places the object and device down, the handle 1500 is rotated in the direction marked by arrow “C”. This causes handle finger 1530 to rotate in the direction marked by arrow “D”, releasing the object.

Therefore the devices grasps and lifts with a single motion of handle 1510.

It also releases the object by setting it down. This is very useful in moving a large number of objects, such as blocks, in a repetitive fashion.

Different attachment means may be used for parts 1253, 1110 and 1111 and remain within the spirit of the invention. Also different types of pivots 1710 may be used. Other means of adjusting the spacing between cross bar fingers 1270 may also be used.

In an alternative embodiment of the present invention, instead of pivot assembly 1700 attaching to different adjustment points 1111 of main bar 1110 to adjust the distance between the handle finger and the cross bar fingers, the main body may change its length by telescoping or folding. This is also within the scope of the present invention.

Various parts of the carrier device 1000 may be manufactured from square stock, angle iron, flat bars, tubular stock or rolled stock.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A carrier device [1000] for carrying an object [3] comprising:
a) a handle assembly [1500] being substantially horizontal, the handle section [1500] having:
i. a handle [1510], and
ii. a handle finger [1530] extending downwardly alongside a front side of the object [3],
b) a main body [1110] having a front side and a rear side, the rear side having at least one cross bar finger [1270] extending downwardly alongside a rear side of said object [3],
c) a pivot assembly [1700] for pivotally attaching the handle assembly [1500] to the main body [1110] at a pivot [1710] such that when the handle [1510] is lifted vertically, it causes the handle finger [1530] to press the object [3] against the cross bar finger [1270] holding said object [3].

2. The carrier device [1000] of claim 1, wherein there are at least 2 cross bar fingers [1270] extend downwardly along side of the rear side of the object [3].

3. The carrier device [1000] of claim 1, wherein a distance between the handle finger [1530] and the cross bar fingers [1270] is adjustable to pick up differently sized objects [3].

4. The carrier device [1000] of claim 1, wherein a distance between the pivot [1710] and the cross bar fingers [1270] is adjustable to pick up differently sized objects [3].

5. The carrier device [1000] of claim 1, wherein a length of the main body [1110] is adjustable to pick up differently sized objects [3].

6. The carrier device [1000] of claim 1, wherein the main body [1110] is a flat bar with adjustment points [1111].

7. The carrier device [1000] of claim 1, wherein the main body [1110] is tubular and has a plurality of adjustment points [1111].

8. The carrier device [1000] of claim 1, wherein the handle finger [1530] is substantially perpendicular to the handle [1510].

9. The carrier device [1000] of claim 1, wherein the main body [1110] has a slider assembly [1200] with a cross bar [1230] with a left side and a right side, where a cross bar finger [1270] extends from its left side and another cross bar finger [1270] extends from its right side.

10. The carrier device of claim 1, wherein the cross bar [1230] further includes a cross bar slider [1231] capable of sliding along the cross bar [1230] wherein at least one cross bar finger [1270] is attached to the cross bar slider [1231], and a cross bar securing device [1290] capable of securing the cross bar slider [1231] at a desired location within the cross bar [1230] causing the cross bar finger [1270] to be secured at a desired location.

11. A carrier device [1000] for holding and carrying various sized objects [3] comprising:
a) a main body [1110] extending generally horizontally;
b) a slider assembly [1200] having a slide [1250] slideably attached to the main body [1110] having at least one cross bar [1230] attached to the slide [1250] and extending horizontally at least partially across main body [1110] and at least one cross bar finger [1270] attached to the cross bar [1230] extending downwardly;
c) a handle assembly [1500] having a handle [1510] for carrying the carrier device [1000], and a handle finger [1530] angled with respect to the handle for making contact with said object [3];
d) a pivot assembly [1700] for attaching the handle assembly [1500] to the main body [1110] allowing the handle finger [1530] of the handle assembly [1500] to pivot when the handle [1510] is lifted to compress said object [3] between the handle finger [1530] and the at least one cross bar fingers [1270] holding and carrying object [3].

12. The carrier device [1000] of claim 11, wherein there are at least 2 cross bar fingers [1270] extending downwardly alongside of the rear side of said object [3].

13. The carrier device [1000] of claim 11, wherein a distance between the handle finger [1530] and the at least one cross bar finger [1270] is adjustable to pick up differently sized objects [3].

14. The carrier device [1000] of claim 11, wherein a distance between the pivot [1710] and the cross bar fingers [1270] is adjustable to pick up differently sized objects [3].

15. The carrier device [1000] of claim 11, wherein a length of the main body [1110] is adjustable to pick up differently sized objects [3].

16. The carrier device [1000] of claim 11, wherein the main body [1110] is a flat bar with adjustment points [1111].

17. The carrier device [1000] of claim 11, wherein the main body [1110] is tubular and has a plurality of adjustment points [1111].

18. The carrier device [1000] of claim 11, wherein the handle finger [1530] is substantially perpendicular to the handle [1510].

19. The carrier device [1000] of claim 11, wherein there are at least two downwardly extending cross bar fingers [1270].

20. The carrier device of claim 19, wherein a relative distance between the cross bar fingers [1270] can be adjusted.
